(19) United States
(12) Patent Application Publication
(10) Pub. No.: US 2006/0100332 A1
(43) Pub. Date: May 11, 2006

(54) Polyester-polyacrylate dispersions with reactive diluents based on compounds containing lactone groups

(75) Inventors: Rolf Gertzmann, Leverkusen (DE); Heinz-Dietmar Gewiss, Meerbusch (DE); Thomas Munzmay, Dormagen (DE); Martin Melchiors, Leichlingen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/270,218

(22) Filed: Nov. 9, 2005

(30) Foreign Application Priority Data
Nov. 11, 2004 (DE) 102004054499.9

(51) Int. Cl. C08K 5/05

(52) U.S. Cl. 524/386; 524/556

(57) ABSTRACT

The present invention related to a process for preparing aqueous polyester-polyacrylate dispersions having a cosolvent content of 0 to 5% by weight, based on the weight of the dispersion, by preparing a polymer P) in a first step by polymerizing A) a mixture of vinyl monomers that are capable of free-radical copolymerization, in the presence of B) one or more oligoesters prepared from compounds containing lactone groups and having a hydroxyl number of 145 to 710 mg KOH/g, an acid number of ≦0.5 mg KOH/g solids and an average OH functionality of 2.5 to 5 mg KOH/g solids, and then mixing polymer P) in a second step with C) one or more polyester polyols having a hydroxyl number of 10 to 500 mg KOH/g solids and an acid number of >0.5 to ≦30 mg KOH/g solids and dispersing the resulting polymer mixture in water in a further step, before or after addition of a neutralizing agent. The present invention also relates to the aqueous polyester-polyacrylate polymer dispersions obtained in accordance with the process of the invention and to aqueous coating compositions containing the aqueous polyester-polyacrylate polymer dispersions of the invention.

### BACKGROUND OF THE INVENTION

1. Field of the Invention

The present invention relates to aqueous polymer dispersions having a low solvent content containing a mixture of hydrophilic polyacrylate-polyester resin blends and reactive diluents having lactone groups, to a process for preparing them, to aqueous coating compositions based thereon and to their use as coating materials.

2. Description of Related Art

From the prior art it is known that water-dilutable, copolymer-based binders are used in coating systems. These binders, however, generally contain low molecular weight emulsifiers for stabilization and/or relatively large proportions of organic cosolvents. Normally the emulsifiers influence the properties of the coating compositions and/or of the coatings, such as their water resistance, film-form optical qualities (gloss) or pigmentability, in an adverse way.

The use of sizable amounts of organic solvents is undesirable on environmental grounds, but is usually impossible to avoid, since during the preparation of the polymer it is necessary to ensure sufficient stirability and removal of heat from the reaction mixture. Additionally, organic solvents in aqueous coating compositions lead to advantageous effects, such as to enhanced storage stability and pigment wetting, improved film-form optical qualities and enhanced flow.

On the other hand, reducing the amount of solvents in copolymers or copolymer dispersions is associated with high levels of cost and inconvenience in terms of apparatus and energy. Accordingly, there is a need for aqueous polymer dispersions which can be prepared largely without the use of organic solvents and without detriment to the performance properties.

Polymer dispersions which are to be cured by means of a chemical reaction, with, for example, an amino resin, a blocked polyisocyanate or a polyisocyanate, are required to contain a certain amount of reactive groups, such as hydroxyl groups. These groups are generally introduced into the copolymer through the accompanying use of hydroxy-functional (meth)acrylic esters during the copolymerization. In comparison to the non-functional (meth)acrylic esters or to styrene, however, the preceding raw materials are very expensive. Also, it is frequently also necessary to use larger amounts of these raw materials to prepare aqueous polymers in comparison to copolymers in organic solution, in order to compensate for the hydrophilic nature of the coating films by means of a greater crosslinking density.

DE-A 39 10829 describes heat-curable coating materials based on polyester-polyacrylates which have a solvent content of between 5% and 20% by weight, based on the coating composition in ready-to-apply form. Preferred solvents specified include water-miscible alcohols, ketones or glycol ethers or water-immiscible solvents. Since the solvents disclosed are not incorporated into the coating, they are released again, during the processing of the coating system, as volatile organic compounds (VOCs). The aforementioned glycol derivatives, which have a low volatility, remain in part in the coating and may impair its properties.

Another route to the preparation of hydroxy-functional secondary copolymer dispersions that largely avoids the use of solvents for the polymerization is described in EP-A 0 758 007. There, the solvents usually used are replaced in whole or in part by hydroxy-functional polyethers. The hydroxyl-functional polyethers remain as reactive diluents in the secondary dispersion and react during the subsequent crosslinking with isocyanates or blocked isocyanates, forming urethane. A disadvantage found with these products, however, is their poor stability, particularly the weathering stability.

GB-A 2 078 766 describes a way of reducing the solvent content of coating compositions during their preparation. Solvent-borne binders are prepared with pigments and additives that are known in the coating industry, using different reactive diluents. The reactive diluents are reaction products of glycidyl esters with compounds containing hydroxyl or carboxyl groups. The disadvantage of the coating materials described in GB-A 2 078 766 is the high solvent content, despite the use of the reactive diluent, since considerable amounts of a cosolvent are incorporated through the binder. Example I of GB-A 2 078 766, for example, uses a binder having a solvent content of 35% by weight.

It is an object of the present invention to provide polymer dispersions containing hydrophilic polyacrylate resins and polyester resins which may be prepared without use of emulsifiers or large amounts of organic solvents and which produce coatings having very good mechanical and optical properties.

This object may be achieved with aqueous polymer dispersions containing mixtures of carboxylate- and hydroxy-functional polyacrylate resins and polyesters having a solvent content below 5% by weight, based on the weight of the dispersion. Coating films with a high level of resistance can be prepared if hydroxy-functional polycaprolactones are used as reactive diluents.

### SUMMARY OF THE INVENTION

The present invention related to a process for preparing aqueous polyester-polyacrylate dispersions having a cosolvent content of 0 to 5% by weight, based on the weight of the dispersion, by preparing a polymer P) in a first step by polymerizing
A) a mixture of vinyl monomers that are capable of free-radical copolymerization,
   in the presence of
B) one or more oligoesters prepared from compounds containing lactone groups and having a hydroxyl number of 145 to 710 mg KOH/g, an acid number of ≦0.5 mg KOH/g solids and an average OH functionality of 2.5 to 5 mg KOH/g solids,
   and then mixing polymer P) in a second step with
C) one or more polyester polyols having a hydroxyl number of 10 to 500 mg KOH/g solids and an acid number of >0.5 to ≦30 mg KOH/g solids
   and dispersing the resulting polymer mixture (P′) in water in a further step, before or after addition of a neutralizing agent.

The present invention also relates to the aqueous polyester-polyacrylate polymer dispersions obtained in accordance with the process of the invention and to aqueous coating compositions containing the aqueous polyester-polyacrylate polymer dispersions of the invention.

### DETAILED DESCRIPTION OF THE INVENTION

Suitable vinyl monomer mixtures A) include building blocks selected from the following compounds:
A1) OH-free (meth)acrylic esters, optionally in admixture with vinylaromatics,
A2) hydroxy-functional vinyl monomers and/or hydroxy-functional (meth)acrylic esters,
A3) ionic and/or potential ionic monomers that are capable of free-radical polymerization, and
A4) monomers that are capable of free-radical polymerization other than the compounds of components A1) to A3).

Suitable monomers for use as component A1) include acrylates and methacrylates (referred to below as (meth)acrylates) having 1 to 18 carbon atoms in the alcohol moiety of the ester group. The alcohol moiety may be linear aliphatic, branched aliphatic or cycloaliphatic. Examples include methyl, ethyl, n-propyl, isopropyl, n-butyl, isobutyl, t-butyl, the isomeric pentyl, hexyl, octyl, dodecyl, hexadecyl, octadecyl or cyclohexyl, trimethylcyclohexyl and isobornyl (meth)acrylates. Also suitable are acetoacetoxyethyl methacrylate, acrylamide, diacetoneacrylamide, acrylonitrile, styrene, vinyl ethers, methacrylonitrile, vinyl acetates, optionally substituted styrenes and vinyltoluenes.

Preferred are the methyl, isopropyl, n-butyl, isobutyl, t-butyl, 2-ethylhexyl, cyclohexyl and isobornyl (meth)acrylates and also styrene. It is also possible to use of any desired mixtures of the abovementioned compounds A1).

Suitable components A2) include ethylenically unsaturated, hydroxyl-containing monomers such as the hydroxyalkyl esters of unsaturated carboxylic acids, preferably hydroxyalkyl (meth)acrylates having 2 to 12, preferably 2 to 6, carbon atoms in the hydroxyalkyl radical. Preferred compounds include 2-hydroxyethyl (meth)acrylate, the isomeric hydroxypropyl (meth)acrylates, 2-, 3- and 4-hydroxybutyl (meth)acrylates, the isomeric hydroxyhexyl (meth)acrylates and 1,4-cyclohexanedimethanol monomethacrylate.

Also suitable are polymerizable hydroxy-functional monomers which have been chain extended or modified with alkylene oxides and which have a number average molecular weight ≦3000 g/mol, preferably ≦700 g/mol. Preferred alkylene oxides include ethylene, propylene or butylene oxide, individually or in mixtures. Examples include Bisomer® PEA3 (polyethylene glycol monoacrylate; 3 ethylene oxide units), Bisomer® PEM 6 LD (polyethylene glycol monomethacrylate; 6 ethylene oxide units), Bisomer® PPM 63 E (polyethylene glycol monomethacrylates, 6 propylene oxide units and 3 terminal ethylene oxide units) or Bisomer® PEM 63 P (polyethylene glycol monomethacrylates; 6 ethylene oxide units and 3 terminal propylene oxide units) from Degussa AG (Darmstadt, Germany).

Also suitable are polymerizable, non-ionic, hydrophilic alkoxypolyethylene glycol (meth)acrylates having number average molecular weights (Mn) of 430 to 2500 g/mol. Examples include Bisomer® MPEG 350 MA (Mn=430 g/mol), 550 MA (Mn=628 g/mol), S 7 W (Mn=818 g/mol), S 10 W (Mn=1080 g/mol) and S 20 W (Mn=2080 g/mol) from Degussa AG (Darmstadt, Germany).

Ionic or potential ionic hydrophilic compounds A3) are all compounds which contain at least one group capable of free-radical polymerization and also at least one functionality, such as —COOY, —SO₃Y, —PO(OY)₂ (wherein Y is, for example, H, NH₄⁺ or a metal cation), —NR₂ or —NR₃⁺ (wherein R is H, alkyl or aryl and wherein radicals R may be identical or different from one another in one molecule), which on interaction with aqueous media enter into a pH-dependent dissociation equilibrium and can have a negative, positive or neutral charge.

Suitable ionic and/or potential ionic monomers of component A3), which are capable of free-radical polymerization, are preferably olefinically unsaturated monomers containing carboxylic acid or carboxylic anhydride groups. Examples include acrylic acid, methacrylic acid, β-carboxyethyl acrylate, crotonic acid, fumaric acid, maleic anhydride, itaconic acid or monoalkyl esters of dibasic acids and/or anhydrides such as maleic acid monoalkyl esters. Preferred are acrylic acid and/or methacrylic acid.

Also suitable as compounds of component A3) are unsaturated, free-radically polymerizable compounds containing phosphate and/or phosphonate or sulphonic acid and/or sulphonate groups, as described for example in WO-A 00/39181 (p. 8 l. 13-p. 9 l. 19). Within this group of components 2-acrylamido-2-methylpropanesulphonic acid is preferred.

Optionally, it is possible to use monomers capable of free-radical polymerization, other than components A1) to A3), as compounds of component A4). These compounds include (meth)acrylate monomers and/or vinyl monomers with a functionality of two or more, such as ethanediol di(meth)acrylate, hexanediol di(meth)acrylate, 1,4- or 1,3-butanediol dimethacrylate, di-, tri- and oligoethylene glycol dimethacrylates, polypropylene glycol dimethacrylates, polytetramethylene glycol dimethacrylates or divinylbenzene.

The hydrophilicity of polymers P) is preferably obtained only through ionic and/or potential ionic groups, more preferably anionic and/or potential anionic groups.

The amounts of components A1) to A4) is selected such that polymer P) has an OH number of 12 to 350 mg KOH/g, preferably of 20 to 200 mg KOH/g and more preferably of 50 to 150 mg KOH/g solids, and an acid number of 5 to 80 mg KOH/g, preferably 10 to 35 and more preferably of 15 to 30 mg KOH/g solids.

Suitable oligoesters B) include reaction products of known lactones b1) with alcohols b2) having a functionality of two or more. Suitable lactones b1) are γ-butyrolactone, valerolactone and ε-caprolactone and mixtures of these lactones. Preferred is ε-caprolactone.

The low molecular weight alcohols b2) are the known hydroxy-functional compounds having a molecular weight of 62 to 250 g/mol and an average hydroxyl functionality of 2.5 to 5, more preferably 2.8 to 3.2.

Examples of low molecular weight alcohols b2) include ethanediol, di-, tri-, tetraethylene glycol, 1,2-propanediol, di-, tri-, tetrapropylene glycol, 1,3-propanediol, butane-1,4-diol, butane-1,3-diol, butane-1,2-diol, pentane-1,5-diol, hexane-1,6-diol, 2,2-dimethyl-1,3-propanediol, 1,4-dihydroxy-cyclohexane, 1,4-dimethylolcyclohexane, octane-1,8-diol, decane-1,10-diol, dodecane-1,12-diol, glycerol, trimethylolethane, trimethylolpropane, pentaerythritol, dipentaerythritol and mixtures thereof. Preferred are glycerol, trimethylolpropane and pentaerythritol, especially trimethylolpropane.

Particularly preferred oligoesters are reaction products of ε-caprolactone with pentaerythritol, trimethylolpropane or neopentyl glycol or with mixtures of these alcohols.

The preparation of compounds B) from components b1) and b2) generally takes place separately and is wholly or partly carried out before the free-radical polymerization, i.e., before the unsaturated monomers A1) to A4) are added and polymerized. If only a portion of compound B) or components b1) and b2) are included in the initial charge, then the remaining amounts of compound B) are added in accordance with the viscosity of the reaction mixture, during or after the polymerization.

The amount of compound B) or the monomer mixture of b1) and b2) is 5% to 60%, preferably 7% to 35% and more preferably 10% to 30% by weight, based on the amount of polymer mixture (P′). The oligoesters have a hydroxyl number of 145 to 710 mg KOH/g, an acid number of ≦0.5 mg KOH/g solids and an average OH functionality of 2.5 to 5, preferably 2.8 to 3.2, mg KOH/g solids.

Suitable polyester polyols C) are prepared by conventional polycondensation of the starting materials, which are selected from the following compounds:
C1) aliphatic and/or cycloaliphatic and/or aromatic mono-, di-, tri- or tetracarboxylic acids or their anhydrides,
C2) alcohols with a functionality of two and/or more,
C3) monohydric alcohols, and
C4) hydroxycarboxylic acids, lactones, aminoalcohols and/or aminocarboxylic acids.

The polyester polyols have a hydroxyl number of 10 to 500, preferably 80 to 350 mg KOH/g solids and an acid number of >0.5 to ≦30, preferably ≧1 to ≦8 mg KOH/g solids.

Suitable carboxylic acids C1) include monocarboxylic acids such as benzoic acid, cyclohexanecarboxylic acid, 2-ethylhexanoic acid, caproic acid, caprylic acid, capric acid, lauric acid, natural and synthetic fatty acids; dicarboxylic acids and/or anhydrides such as phthalic acid, phthalic anhydride, isophthalic acid, hexahydrophthalic acid, hexahydrophthalic anhydride, succinic acid, succinic anhydride, adipic acid, dodecanedioic acid, hydrogenated dimer fatty acids; carboxylic acids and/or anhydrides of higher functionality such as trimellitic acid and trimellitic anhydride; and mixtures of these compounds. Dicarboxylic acids and dicarboxylic anhydrides are preferred.

Suitable unsaturated carboxylic acids include tetrahydrophthalic acid, tetrahydrophthalic anhydride, maleic anhydride, fumaric acid, crotonic acid, unsaturated fatty acids (such as soya oil fatty acid or tall oil fatty acid) and mixtures of these and other unsaturated monocarboxylic or dicarboxylic acids.

Dicarboxylic acids and dicarboxylic anhydrides are preferred. Especially preferred are cyclic dicarboxylic acids such as phthalic acid, phthalic anhydride, isophthalic acid, hexahydrophthalic acid or hexahydrophthalic anhydride.

Suitable components C2) include (cyclo)alkanediols (i.e. dihydric alcohols with (cyclo)aliphatically attached hydroxyl-groups) having a molecular weight of —62 g/mol to 286 g/mol, such as ethanediol, 1,2- and 1,3-propanediol, 1,2-, 1,3- and 1,4-butanediol, 1,4-butenediol, 1,5-pentanediol, 1,6-hexanediol, neopentyl glycol, cyclohexane-1,4-dimethanol, 1,2- and 1,4-cyclohexanediol, 2-ethyl-2-butylpro-panediol; diols containing ether groups, such as diethylene glycol, triethylene glycol, tetraethylene glycol, dipropylene glycol, tripropylene glycol. Also suitable are polyethylene, polypropylene or polybutylene glycols having a maximum number average molecular weight of 2000 g/mol, preferably 1000 g/mol and more preferably 500 g/mol. Reaction products of the preceding diols with ε-caprolactone may also be employed as diols. Suitable alcohols with a functionality three or more include glycerol, trimethylolpropane, pentaerythritol, dipentaerythritol and sorbitol, and also mixtures of these compounds. Preferred are hexanediol, neopentyl glycol, 1,4 cyclohexanedimethanol and trimethylolpropane.

Optionally, it is also possible to use as component C3), monoalcohols such as ethanol, 1- and 2-propanol, 1- and 2-butanol, 1-hexanol, 2-ethylhexanol, cyclohexanol, benzyl alcohol and mixtures of these compounds. 2-ethylhexanol is preferred.

Optionally, it is possible to use as components C4), hydroxycarboxylic acids having 2 to 10 carbon atoms, lactones of these acids, amino alcohols having a molecular weight of 61 to 300 and/or aminocarboxylic acids having a molecular weight of 75 to 400. Examples include hydroxypivalic acid, dimethylolpropionic acid, dimethylolbutyric acid, lactic acid, malic acid, tartaric acid, ε-caprolactone, aminoethanol, aminopropanol, diethanolamine, aminoacetic acid, aminohexanoic acid and mixtures of these compounds. ε-caprolactone is preferred.

Polyester C) can optionally be prepared in the presence of known esterification catalysts, preferably by melt condensation or azeotropic condensation at temperatures of 140 to 240° C. with elimination of water. The amount of polyester C) is selected such that the weight fractions of components A1) to A4) relative to C) amount to 25:75 to 90:10, preferably 35:65 to 85:15 and more preferably 50:50 to 80:20.

In general the process for preparing the polyester-polyacrylate dispersions of the invention takes place in accordance with known processes. Compound B) or the monomer mixture of b1) and b2) is charged to a reaction vessel and the unsaturated monomers A1) to A4) are metered in and polymerized using a free-radical initiator. It is also possible to include only a fraction of compounds B) or the monomer mixture of b1) and b2) in the initial charge prior to the polymerization, in order to ensure thorough mixing of the reaction components A1) to A4) right at the start of the polymerization. A further addition of the compound B) or the monomer mixture b1) and b2) then takes place during the polymerization of monomers A1) to A4). The polymerization is carried out at 40 to 200° C., preferably at 60 to 180° C. and more preferably at 80 to 160° C.

It may be necessary for additional organic solvents to be used in a minor amount, particularly when they are used to dilute the initiators. Suitable auxiliary solvents are the known solvents from coating technology, such as alcohols, ethers, alcohols containing ether groups, esters, ketones, N-methylpyrrolidone apolar hydro-carbons and mixtures of these solvents. The solvents are used in amounts such that they are present in the finished dispersion at 0 to 5%, preferably 1% to 3%, by weight. If required, the solvents used can be removed again in whole or in part by means of a distillation.

Suitable initiators for the polymerization reaction include organic peroxides such as di-tert-butyl peroxide, dicumyl peroxide, 2,5-dimethyl-2,5-di(tert-butylperoxy)-hexane, tert-butyl peroxybenzoate, dibenzoyl peroxide, tert-butyl perisobutyrate or tert-butyl peroxy-2-ethylhexanoate and azo compounds such as azobisisobutyro-nitrile (AIBN). The amounts of initiator used depend on the desired molecular weight. For reasons of operational reliability and better handling it is also possible to use peroxide initiators in the form of a solution in suitable organic solvents of the type specified above.

The preparation of polymer P) takes place preferably in two steps (i) and (ii). In the first step (i) a hydroxy-functional monomer mixture (A′) having an OH number of 12 to 350 mg KOH/g solids, preferably 20 to 200 mg KOH/g solids and an acid number of 0 to 50 mg KOH/g solids, preferably 0 to 30 mg KOH/g solids, is added to compound B), which has already been introduced. In this case 50% to 90%, preferably 60% to 80% by weight of component A1), 2% to 50%, preferably 5% to 35% by weight of component A2), 0 to 7%, preferably 0 to 5% by weight of component A3) and 0 to 50%, preferably 3% to 30%, by weight of component A4) are mixed with one another.

In a subsequent step (ii) a further monomer mixture (A″) made up of monomers of components A1) to A4) is added to the reaction mixture obtained from step (i). Monomer mixture (A″) has an OH number of 10 to 350 mg KOH/g solids, preferably 18 to 200 mg KOH/g solids and an acid number of 50 to 300 mg KOH/g solids, preferably 70 to 200 mg KOH/g solids. The monomer mixture (A″) from step (ii) contains 45% to 85%, preferably 55% to 75% by weight of component A1), 1% to 50%, preferably 5% to 35% by weight of component A2), 3% to 30%, preferably 8% to 22% by weight of component A3) and 0 to 50%, preferably 3% to 30% by weight of component A4).

The percentages of the monomer composition (A′) and (A″) add up to 100% by weight. The monomer amounts of the two polymer preparations are chosen such that the weight ratio of monomer mixture (A′) to monomer mixture (A″) is 10:1 to 1:2, preferably 6:1 to 2:1.

Instead of a multistage polymerization process it is possible to carry out the operation continuously (gradient polymerization); i.e., a monomer mixture is added with a composition which changes over time, preferably with the hydrophilic monomer fractions in accordance with components A3) and optionally A4) being higher towards the end of the feed than at the beginning.

Polymers P) have number average molecular weights, Mₙ, of 500 to 30,000 g/mol, preferably 1000 to 15,000 g/mol and more preferably 1500 to 10,000 g/mol.

The polyester C) is added after the polymerization of the monomer composition A′), but preferably after the polymerization of the monomer mixture A″), and very particularly preferably before the addition of a neutralizing agent. Polyester C) is added at temperatures of 40-200° C., preferably 60-180° C., and particularly preferably 80-160° C., to the polymer A′), and preferably to P), and mixed with the resin already introduced. The polyester can contain for reducing the viscosity and thus for facilitating handling, a certain amount of solvents in quantities of 0.5 to 95%, preferably 1 to 60%, and particularly preferably 1 to 40%, based on the total quantity of solvent in the polymer mixture (P′). In addition, it is also possible to add portions of component B) to the polyester C).

Before, during or after the dispersion of hydroxy-functional polymers P) in water the acid groups present are converted at least partially into their salt form by the addition of suitable neutralizing agents. The potential ionic groups of polymer P) are preferably neutralized prior to dispersion. Suitable neutralizing agents include organic amines or water-soluble inorganic bases, such as soluble metal hydroxides, carbonates or hydrogen carbonates, for example.

Examples of suitable amines include N-methylmorpholine, triethylamine, ethyldiisopropylamine, N,N-dimethylethanolamine, N,N-dimethylisopropanol-amine, N-methyldiethanolamine, diethylethanolamine, triethanolamine, butanol-amine, morpholine, 2-aminomethyl-2-methylpropanol or isophoronediamine. In mixtures it is also possible to use ammonia. Preferred are triethanolamine, N,N-dimethylethanolamine and ethyldiisopropylamine.

The neutralizing agents are added in amounts such that there is a theoretical degree of neutralization [of the acid groups] of 40% to 150%, preferably 60% to 120%. The degree of neutralization is the molar ratio of added basic groups of the neutralizing component to acid groups of polymer P).

The pH of the polyester-polyacrylate dispersion of the invention is 6 to 10, preferably 6.5 to 9.

The aqueous, hydroxy-functional polyester-polyacrylate dispersions of the invention have a solids content of 25% to 70%, preferably 35% to 60% and more preferably of 40% to 55% by weight.

The polyester-polyacrylate dispersions of the invention can be processed to aqueous coating compositions. Through a combination of crosslinkers it is possible, depending on the reactivity or, where appropriate, blocking of the crosslinkers, to prepare both one-component coating compositions and two-component coating compositions.

One-component coating compositions are coating compositions where the binder component and crosslinker component can be stored together without a crosslinking reaction taking place to any significant extent or any extent detrimental to the subsequent application. The crosslinking reaction takes place only on application, following activation of the crosslinker. This activation can be brought about, for example, by an increase in temperature.

Two-component coating compositions are coating compositions where the binder component and crosslinker component have to be stored in separate vessels, due to their high reactivity. The two components are not mixed until shortly before application, where they react generally without additional activation. For accelerating the crosslinking reaction, though, it is also possible to use catalysts or to employ relatively high temperatures. The use of the polyester-polyacrylate dispersions of the invention in two-component coating compositions is preferred.

Examples of suitable OH-reactive crosslinkers are polyisocyanate crosslinkers, amide- and amine-formaldehyde resins, phenolic resins, aldehyde resins and ketone resins, such as phenol-formaldehyde resins, resoles, furan resins, urea resins, carbamic ester resins, triazine resins, melamine resins, benzoguanamine resins, cyanamide resins, and aniline resins, as described in “Lackkunstharze”, H. Wagner, H. F. Sarx, Carl Hanser Verlag Munich, 1971.

Preferred crosslinkers are polyisocyanates, which typically have two or more NCO groups per molecule and are prepared from, for example, isophorone diisocyanate, hexamethylene diisocyanate, 1,4-diisocyanatocyclohexane, bis(4-isocyanatocyclohexane)methane, 1,3-diisocyanatobenzene, triisocyanatononane or the isomeric 2,4- and 2,6-TDI, and may contain urethane, isocyanurate and/or biuret groups. Optionally, the polyisocyanates may also have been blocked. Particular preferred are low-viscosity, optionally hydrophilic polyisocyanates of the preceding type based on aliphatic or cycloaliphatic isocyanates.

The polyisocyanates used as crosslinkers generally have a viscosity at 23° C. of 10 to 5000 mPas and may also be used for viscosity adjustment in a blend with small amounts of inert solvents.

Polymers P) are generally sufficiently hydrophilic that even hydrophobic crosslinker resins can be dispersed without additional emulsifiers. The use of external emulsifiers, however, is not excluded.

Water-soluble or dispersible polyisocyanates are obtained, for example, through modification with carboxylate, sulphonate and/or polyethylene oxide groups and/or polyethylene oxide/polypropylene oxide groups. Hydrophilic modification of the polyisocyanates is possible, for example, through reaction with less than equivalent amounts of monohydric, hydrophilic polyether alcohols. The preparation of hydrophilic polyisocyanates of this kind is described, for example, in EP-A 0 540 985 (p. 3,1.55 to p.4 1.5).

Also highly suitable are polyisocyanates which contain allophanate groups and are described in EP-A 959 087 (p. 3 11. 39 to 51). They are prepared by reacting low monomer content polyisocyanates with polyethylene oxide polyether alcohols under allophanatization conditions. The water-dispersible polyisocyanate mixtures that are based on triisocyanatononane and described in DE-A 100 078 21 (p. 2 1. 66 to p. 3 1. 5) are also suitable, as are polyisocyanates hydrophilically modified with ionic groups (sulphonate groups, phosphonate groups), as described for example in DE 100 24 624 (p. 3 11. 13 to 33). It is also possible to use mixtures of different crosslinker resins.

Before, during or after the preparation of the aqueous, polyester-polyacrylate dispersion of the invention it is -possible to add the known additives of coating technology, such as defoamers, thickeners, pigments, dispersing assistants, catalysts, anti-skinning agents, anti-settling agents or emulsifiers. These additives can also be added to the coating compositions containing the aqueous, hydroxy-functional polyester-polyacrylate dispersions of the invention.

The aqueous coating compositions containing the aqueous, hydroxy-functional polyester-polyacrylate dispersions of the invention are suitable for all fields of use in which aqueous paint systems and coating systems with exacting requirements regarding the resistance of the films are employed, for example, for coating surfaces of mineral building materials, for coating and sealing wood and wood-based materials, for coating metallic surfaces (metal coating), for coating and painting asphaltic or bituminous coverings, for painting and sealing various plastics surfaces (plastics coating), and for high-gloss varnishes.

The aqueous coating compositions containing the aqueous, polyester-polyacrylate dispersions of the invention are used for producing primers, surfacers, pigmented or transparent topcoat materials, clearcoat materials and high-gloss varnishes and also one-coat materials which can be employed in individual application and mass application, e.g. in the field of industrial coating, automotive OEM finishing and automotive refinishing. Preferably, they are used as a multi-coat system, where the topmost coat is a topcoat or clearcoat produced by curing the aqueous, polyester-polyacrylate dispersion of the invention.

The coatings can be produced by any of a variety of spraying methods such as air-pressure, airless or electrostatic spraying processes, using one- or optionally two-component spraying units. The coating compositions and coating compositions containing the aqueous, hydroxy-functional polyester-polyacrylate dispersions of the invention can also be applied by other methods, such as by brushing, rolling or knifecoating.

### EXAMPLES

Unless indicated otherwise, all percentages are by weight.

Viscosity measurements were carried out using a Physica Viscolab® LC3 ISO cone-plate viscometer from Physica, Stuttgart, Germany in accordance with DIN 53019 at a shear rate of 40 s⁻¹.

The average particle size was determined by means of laser correlation spectroscopy (HPPS, Malvern Instruments, Herrenberg, DE).

The reported OH numbers were calculated on the basis of the monomers employed.

Acid numbers: method of determination, DIN ISO 3682

Peroxan® DB: di-tert-butyl peroxide, Pergan GmbH, Bucholt, Germany.

### Example 1

### Reactive Diluent

A 15 liter reaction vessel with stirring, cooling and heating means was charged with 359.4 g (3.15 mol) of ε-caprolactone together with 140.8 g (1.05 mol) of trimethylolpropane and this initial charge was heated to 100° C. with stirring over the course of 90 minutes. The mixture was then heated rapidly, over the course of 40 minutes, to 150° C. and held there with stirring for three hours. Subsequently it was cooled to room temperature and the clear, low-viscosity mixture was run off.

OH number: 350 mg KOH/g

Viscosity: 28 mPas/23° C. (D=1000)

### Example 2

### Polyester Precursor

A 20 liter reaction vessel with stirring, cooling and heating means and water separator was charged at 20° C. with 1659 g of trimethylolpropane and 5146 g of neopentyl glycol and this initial charge was melted at 100° C. Then, with stirring, 122 g of maleic anhydride, 2059 g of isophthalic acid and 5666 g of phthalic anhydride were added and the mixture was heated to 150° C. over the course of one hour, during which a stream of nitrogen was passed through it. Subsequently the temperature was adjusted to 200° C. over the course of 6 h and condensation was carried out in the stream of nitrogen until the acid number feall below 8 mg KOH/g solids.

Acid number: 5.9 mg KOH/g

OH number: 122 mg KOH/g

### Example 3

A 4 liter reaction vessel with stirring, cooling and heating means was charged with 123.4 g of the reactive diluent from Example 1 and heated to 140° C. At this temperature 11.3 g of Peroxan® DB were added dropwise over the course of 125 minutes. Five minutes after the metered addition of the initiator solution had begun, a monomer mixture of 185 g of methyl methacrylate, 150 g of hydroxyethyl methacrylate, 50 g of butyl acrylate, 50 g of isobutyl methacrylate and 35 g of styrene was metered in over the course of 2 h. Immediately thereafter a mixture of 92.5 g of methyl methacrylate, 75 g of hydroxyethyl methacrylate, 25 g of butyl acrylate, 25 g of isobutyl methacrylate, 17.5 g of styrene and 45 g of acrylic acid was metered in over the course of 60 minutes; in parallel with this a solution of 11.3 g of di-tert-butyl peroxide was metered in at a uniform rate over 2 h. Subsequently the mixture was stirred at 140° C. for 1 hour, before 750 g of the polyester from Example 2—dissolved in 124 g of butyl glycol and heated to 130° C.—were added and the mixture was stirred for a further hour. This was followed by cooling to 100° C. and the addition of 47 g of dimethylethanolamine. After 20 minutes of homogenization the batch was dispersed with 1650 g of water at 90° C. over the course of 10 minutes. The batch was homogenized at the attained mixing temperature of 70° C. for 1 h and at 48° C. for 2.5 hours more, before the dispersion was filtered and cooled to room temperature.

| | |
|---|---|
| OH content (solids) | 4.6% (calculated theoretically) |
| Acid number (solids) | 25.9 mg KOH/g |
| Solids content | 47% |
| Viscosity | 5400 mPas/23° C. |
| pH (10% in water) | 7.6 |
| Degree of neutralization | 75% |
| Average particle size | 170 nm |
| Cosolvent content | 3.67% by weight, based on dispersion |

### Example 4

A 4 liter reaction vessel with stirring, cooling and heating means was charged with 45.7 g of trimethylolpropane and 77.7 g of ε-caprolactam and heated to 100° C. with stirring over the course of 90 minutes. The mixture was then heated rapidly, over the course of 40 minutes, to 150° C. and held there for three hours with stirring. Subsequently it was cooled to 140° C. and admixed with 78.5 g of butyl diglycol. Subsequently a solution of 11.3 g of Peroxan® DB in 22.5 g of butyl diglycol was added dropwise over the course of 125 minutes. Five minutes after the metered addition of the initiator solution had begun, a monomer mixture of 185 g of methyl methacrylate, 150 g of hydroxyethyl methacrylate, 50 g of butyl acrylate, 50 g of isobutyl methacrylate and 35 g of styrene was metered in over the course of 2 h. Immediately thereafter a mixture of 92.5 g of methyl methacrylate, 75 g of hydroxyethyl methacrylate, 25 g of butyl acrylate, 25 g of isobutyl methacrylate, 75 g of hydroxyethyl methacrylate, 25 g of butyl acrylate, 25 g of isobutyl methacrylate, 17.5 g of styrene and 45 g of acrylic acid was metered in over the course of 60 minutes; in parallel with this a solution of 11.3 g of di-tert-butyl peroxide in 23.5 g of butyl diglycol was metered in at a uniform rate over 2 h. Subsequently the mixture was stirred at 140° C. for 1 hour, before 750 g of the polyester from Example 2—heated to 120° C.—were added and the mixture was stirred for a further hour. This was followed by the addition of 45 g of dimethylethanolamine at 100° C. After 20 minutes of homogenization the batch was dispersed with 1725 g of water at 90° C. over the course of 10 minutes. Homogenization was carried out at the attained mixing temperature of 72° C. for a further 1.5 h, before the dispersion was then filtered and cooled to room temperature.

| | |
|---|---|
| OH content (solids) | 4.60% (calculated theoretically) |
| Acid number (solids) | 25.9 mg KOH/g |
| Solids content | 46% |
| Viscosity | 3110 mPas/23° C. |
| pH (10% in water) | 7.5 |
| Degree of neutralization | 75% |
| Average particle size | 185 nm |
| Cosolvent content | 1.5% by weight, based on dispersion |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing an aqueous, hydroxy-functional polyester-polyacrylate dispersion having a cosolvent content of 0 to 5% by weight, based on the weight of the dispersion, which comprises preparing a polymer P) in a first step by polymerizing
A) a mixture of vinyl monomers that are capable of free-radical copolymerization,
in the presence of
B) one or more oligoesters prepared from compounds containing lactone groups and having a hydroxyl number of 145 to 710 mg KOH/g, an acid number of ≦0.5 mg KOH/g solids and an average OH functionality of 2.5 to 5 mg KOH/g solids,
and then mixing polymer P) in a second step with
C) one or more polyester polyols having a hydroxyl number of 10 to 500 mg KOH/g solids and an acid number of >0.5 to ≦30 mg KOH/g solids,
and dispersing the resulting polymer mixture in water in a further step, before or after the addition of a neutralizing agent.

2. The process of claim 1 which comprises charging a reaction vessel with i) compound B) or ii) a mixture of a lactone b1) and an alcohol b2) having a functionality of two or more, which is suitable for preparing compound B), and metering in and polymerizing the unsaturated monomers using a free-radical initiator.

3. The process of claim 2 which comprises
a) adding compound B),
b) during or after step a) adding and polymerizing in a first stage (i) a hydroxy-functional monomer mixture A′) having an OH number of 12 to 350 mg KOH/g solids and an acid number of 0 to 50 mg KOH/g solids and then
c) adding to the reaction mixture obtained in step b) and polymerizing in a second stage (ii) a monomer mixture A″) having an OH number of 10 to 350 mg KOH/g solids and an acid number of 50 to 300 mg KOH/g solids.

4. The process of claim 1 wherein oligoester B) comprises the reaction product of ε-caprolactone with pentaerythritol.

5. The process of claim 1 wherein oligoester B) comprises the reaction product of ε-caprolactone with trimethylolpropane.

6. The process of claim 1 wherein oligoester B) comprises the reaction product of ε-caprolactone with neopentyl glycol.

7. The process of claim 1 wherein oligoester B) comprises the reaction product of pentaerythritol, trimethylolpropane and neopentyl glycol with ε-caprolactone.

8. The polyester-polyacrylate dispersion obtainable by process of claim 1.

9. The polyester-polyacrylate dispersion of claim 8 wherein the polyester-polyacrylate dispersion has a cosolvent content of 1 to 3% by weight, based on the weight of the dispersion.

10. An aqueous coating composition comprising the polyester-polyacrylate dispersion of claim 8.

11. An aqueous two-component coating composition comprising the polyester-polyacrylate dispersion of claim 8.

12. A multi-coat coating wherein topcoat is obtained by curing the polyester-polyacrylate dispersion of claim 8.
